(19) United States
(12) Patent Application Publication
(10) Pub. No.: US 2011/0109009 A1
(43) Pub. Date: May 12, 2011

(54) METHOD OF FORMING UNSUPPORTED DIVISION POST FOR AUTOMOTIVE GLASS ENCAPSULATION

(75) Inventor: Andre Guellec, Bloomfield Township, MI (US)

(73) Assignee: Hutchinson Sealing Systems, Inc., Auburn Hills, MI (US)

(21) Appl. No.: 13/007,034

(22) Filed: Jan. 14, 2011

Related U.S. Application Data
(63) Continuation-in-part of application No. 11/691,129, filed on Mar. 26, 2007.

(51) Int. Cl. B29C 47/02

(52) U.S. Cl. 264/252; 264/254

(57) ABSTRACT

A method of forming a division post assembly for guiding a moveable window panel in a motor vehicle comprises: forming a body portion free of structural metal and coextruding at least one sealing wing with the body portion to form a coextruded assembly. The body portion comprises a first material and has a generally U-shaped cross-section including a base and first and second opposing walls defining a channel configured to receive at least an edge of the moveable window panel. The sealing wing projects into the channel and comprises a second material different than the first material. The body portion and the coextruded assembly exhibit sufficient flexibility for hand manipulation into a curved shape having a first radius of curvature that is substantially the same as a second radius of curvature of a mold cavity of a mold into which the coextruded assembly is configured for placement.

### CROSS REFERENCE TO RELATED APPLICATIONS

This application is a continuation-in-part of U.S. patent application Ser. No. 11/691,129, filed Mar. 26, 2007, now pending (the '129 application). The '129 application is hereby incorporated by reference in its entirety as though fully set forth herein.

### BACKGROUND OF INVENTION

a. Field of the Invention

The invention relates generally to a method of forming a division post assembly for guiding a moveable window panel in a motor vehicle, and in particular, to a method of forming a division post assembly comprising a body portion free of structural metal and exhibiting sufficient flexibility for hand manipulation into a curved shape having a radius of curvature that is substantially the same as a mold cavity of a mold into which the division post assembly is configured for placement.

b. Description of Related Art

Most automotive doors have a body envelope created by two generally-parallel spaced apart inner and outer door panels forming a main body of the door. The top edges of the inner and outer door panels at the bottom of the window opening is often referred to as the belt line. A panel of window glass may be nested between the door panels. A window regulator is provided for selectively moving the glass panel in and out of the body envelope to open and close the window opening of the door. In many motor vehicles, the automotive door has a door frame above the belt line for enclosing the window opening and supporting the window panel in an uppermost position. Many motor vehicles provide both front and rear automotive doors.

The front and rear side door window openings typically have one lateral boundary formed by a post. The posts of the front and rear door window openings are typically fixed to the doors and have longitudinal axes which are parallel with the axis of travel of the window panels. The posts of the front and rear door window openings are adjacent to the B-pillar of the vehicle. The B-pillar is the center body pillar that provides roof support. The tops of the posts are connected with or extend to header regions of the door window openings. The header regions provide an upper border for the window openings. The header region of the front door window frame transitions into a declining region that eventually intersects the belt line of the vehicle. This declining portion of the front window frame is adjacent to the A-pillar of the vehicle. The A-pillar is a front body pillar attached to the front windshield that supports the roof.

The header region of the rear door window frame extends downward, eventually intersecting the belt line of the vehicle. This downward portion of the rear window frame is adjacent to the C-pillar of the vehicle. The C-pillar is a rear body pillar to which the back glass of the motor vehicle is attached that supports the roof. In a number of motor vehicles, the rear door assembly is designed with a forward window opening that carries a retractable window panel and a rearward opening that is equipped with a fixed window glass panel. The rear border of the window opening that carries a retractable window panel is provided by a division post that serves as a track for the moveable window's up and down travel.

Conventionally, the front and rear door assembly may be assembled from discrete elements, including a window panel, the division post, glass run channel, and various configurations of moldings or trim pieces. As a result of being assembled from discrete elements, conventional designs may have a number of deficiencies, such as water leakage, wind noise, and problems with fit and finish. Molding processes have been used in which a portion of the trim surrounding the fixed window glass panel is fabricated by encapsulating the window periphery with a polymer using injection molding techniques. However, the attachment of a discrete glass run channel strip may leave the potential for water leakage and wind noise at the connection areas.

A glass encapsulation molding process may be used to provide an encapsulated fixed window glass panel, where the trim surrounding the fixed window glass panel, the division post, and the glass run channel, all molded as an assembly, form continuous seals around the corner of the moveable glass.

Conventional division posts generally comprise rigid coextrusions made of a flexible elastomeric material extruded around a rigid metal formed carrier. Conventional division posts have a number of deficiencies. First, the metal may be relatively expensive. Second, conventional division posts require both rollform tooling to shape the metal carrier before and after extrusion and stretch bend tooling to match the curvature of both the moveable and fixed glass window panels after extrusion. This tooling may be expensive and complicated.

Accordingly, there remains a need for a method of forming a division post assembly for guiding a moveable window panel in a motor vehicle that minimizes and/or eliminates these deficiencies in the prior art.

### SUMMARY OF THE INVENTION

The present invention provides a method of forming a division post assembly for guiding a moveable window panel in a motor vehicle. The method comprises forming a body portion free of structural metal and coextruding at least one sealing wing with the body portion to form a coextruded assembly. The body portion comprises a first material and has a generally U-shaped cross-section including a base and first and second opposing walls defining a channel. The channel is configured to receive at least an edge of the moveable window panel. The sealing wing projects into the channel and comprises a second material different than the first material. The body portion and the coextruded assembly exhibit sufficient flexibility for hand manipulation into a curved shape having a first radius of curvature that is substantially the same as a second radius of curvature of a mold cavity of a mold into which the coextruded assembly is configured for placement. The first radius of curvature can be at least about 1000 mm in accordance with an embodiment of the invention. The method of forming a division post assembly can further comprise placing the coextruded assembly into the mold; placing a fixed glass window panel into the mold; and forming a mold portion for connecting the coextruded assembly to the fixed window glass panel.

The present invention provides a method of forming a window assembly including a division post. The method comprises: providing a mold having a mold cavity having a first space; providing a division post configured for insertion in the first space of the mold cavity, wherein the division post is free of structural metal, has a generally U-shaped cross section, and defines a channel adapted to receive a moveable window panel and further wherein the division post exhibits sufficient flexibility for hand manipulation into a curved shape having a first radius of curvature that is substantially the same as a second radius of curvature of the first space of the mold cavity; and flexing the division post during placement of the division post into the first space of the mold cavity such that the division post follows a curvature of the mold. The division post is manipulated into a curved shape having the first radius of curvature without undergoing non-trivial operations, such as pre-forming or stretch-bending processing before the division post is placed in the mold.

In some embodiments, the mold cavity has a second space, and the method further comprises: providing a fixed window glass panel configured for insertion in the second space of the mold cavity; and placing the fixed window glass panel in the second space of the mold cavity. The fixed window glass panel is curved in some embodiments of the invention. In some embodiments, the mold cavity also has a third space, and the method further comprises: providing a header glass run channel strip configured for insertion in the third space of the mold cavity, the header glass run channel strip adapted to contact a moveable window panel; and placing one end of the header glass run channel strip into the third space of the mold cavity. The method can further comprise: closing the mold and injecting a resin into the mold to encapsulate at least a portion of the division post with therein. The resin can comprise ethylene propylene diene rubber (EPDM), thermoplastic vulcanizate (TPV), thermoplastic polyolefin (TPO), or polyvinyl chloride (PVC) in accordance with various embodiments of the invention. The method can further comprise encapsulating at least a portion of the fixed window glass panel with the resin; forming a radial trim region integrally bonding the end of the header glass run channel strip with the resin, the radial trim region adapted to seal a portion of the moveable window panel; allowing the resin to cure or cool to form an encapsulated fixed window glass panel assembly having an integral header glass run channel strip; and removing the encapsulated fixed window glass panel assembly having an integral header glass run channel strip from the mold. The division post can be bonded to the curved fixed window glass panel assembly and can retain the curvature of the mold after the encapsulated fixed window glass panel assembly is removed from the mold.

A method of forming a division post assembly in accordance with the present invention is advantageous as compared to existing methods. First, the inventive method of forming a division post assembly eliminates the need for a metal carrier for support and replaces it with a low-cost coextruded material. The coextruded material may have sufficient rigidity to guide and stabilize the window panel, but is configured for use in a glass encapsulation mold. Second, the inventive method eliminates the need for roll form tooling and stretch bend tooling since the division post is sufficiently flexible to no longer require such processing, thus eliminating the expense of the tooling and processing of the division post through that tooling. Third, although the inventive method forms a division post that has sufficient rigidity to guide and stabilize the window panel, the division post is configured for use in a glass encapsulation mold because the division post exhibits sufficient flexibility for hand manipulation into a curved shape having a radius of curvature that corresponds to the radius of curvature of a mold cavity for a typical vehicle door and glass tumblehome. Accordingly, the division post does not undergo a non-trivial operation like pre-forming or stretch-bending (or other similar processes) before the division post is placed into the mold. A substantially straight and flexible division post may instead be flexed to naturally follow the curvature of the mold during loading and/or placement of the division post into the mold. After the glass encapsulation molding operation is complete, the division post is secured to the fixed window glass panel and can retain the curvature imparted by the mold. The division post is thus permanently deformed in the mold, which eliminates the need for non-trivial operations like stretch-bending operations.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention and together with the detailed description serve to explain the principles of the invention. In the drawings:

FIG. 1 is a fragmentary, perspective view of a rear door assembly installed in a motor vehicle.

FIG. 2 is a side, elevational view of a portion of a rear door assembly including a division post in accordance with an embodiment of the invention.

FIG. 3 is a cross-sectional view along line 3-3 of FIG. 2.

FIG. 4 is a flow diagram generally representing an exemplary method of forming a division post assembly for guiding a moveable window panel in a motor vehicle in accordance with an embodiment of the invention.

FIG. 5 is a fragmentary, plan view of the open mold used with the division post in accordance with an embodiment of the invention.

FIG. 6 is a fragmentary, side elevational view of a portion of a rear door assembly including a division post in accordance with the present invention, illustrating the integration of the header trim strip, the fixed window glass panel, and the division post with the injected encapsulation portion of the trim being shown in phantom.

FIG. 7 is a flow diagram generally representing an exemplary method of forming a division post assembly for guiding a moveable window panel in a motor vehicle in accordance with an embodiment of the invention.

FIG. 8 is an exploded view of the components of a rear door assembly including a division post and fixed window glass panel prior to flexing the division post and encapsulation of at least a portion of the division post and fixed window glass panel with resin in accordance with an embodiment of the invention.

FIG. 9 is a side elevational view of a portion of a rear door assembly including a division post and fixed window glass panel subsequent to flexing the division post and encapsulation of at least a portion of the division post and fixed window glass panel in accordance with the present invention.

### DETAILED DESCRIPTION OF THE PREFERRED EMBODIMENT

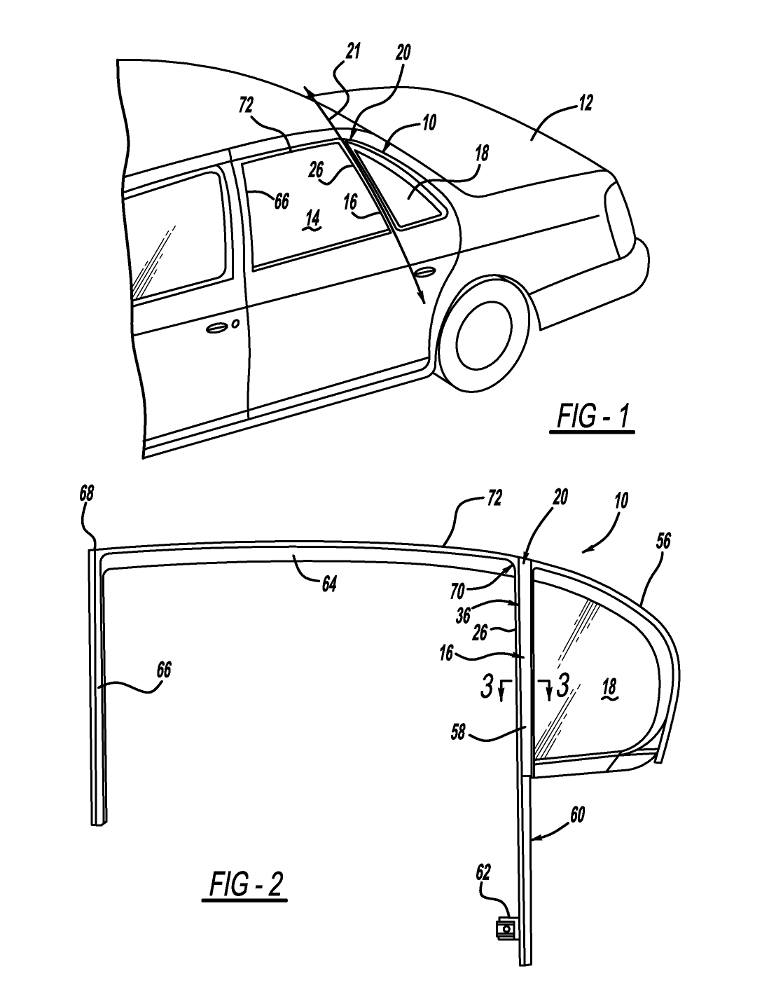

Referring now to the drawings wherein like reference numerals designate corresponding parts throughout the several views, FIG. 1 illustrates a rear door assembly 10 in motor vehicle 12. In FIG. 2, a portion of rear door assembly 10 is shown isolated from motor vehicle 12. Rear door assembly 10 includes a moveable window panel 14, a division post 16, fixed window glass panel 18, and integrated trim 20.

Although a number of materials may be suitable for window panels 14, 18, in most applications window panels 14, 18 may comprise conventional clear or tinted automotive glass panels. In other embodiments, window panels 14, 18 may comprise plastic, such as polycarbonate, polymethyl methacrylate (PMMA), or other glazing type material.

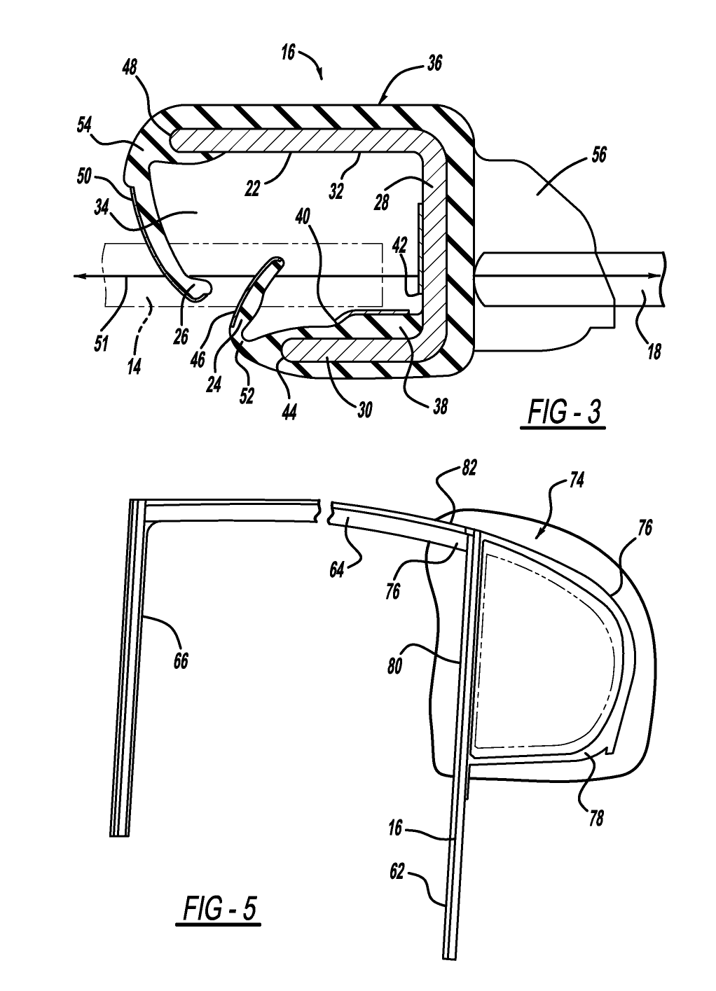

Division post 16 is provided for defining a channel for receiving, supporting, and guiding moveable window panel 14 during its up and down motion in the channel. In particular, division post 16 is provided for guiding a window panel moveable along a first axis 21. As best illustrated in FIG. 3, division post may include a body portion 22 and first and second sealing wings 24, 26.

Body portion 22 is provided for structural rigidity and support in order to guide moveable window panel 14. Body portion 22 may comprise a polymer. In an exemplary embodiment, body portion 22 may comprise polypropylene. Body portion 22 may be free of structural metal. In an exemplary embodiment, body portion 22 may comprise a material with a durometer greater than approximately 90 shore A in order to provide sufficient structural rigidity. Body portion 22 may have a generally U-shaped cross section. Body portion 22 may comprise a base 28 and first and second opposing walls 30, 32. Wall 30 may be shorter or longer in length than wall 32, thereby creating the U-shaped cross-section. Base 28 and first and second opposing walls 30, 32 define channel 34. Channel 34 is configured to receive at least an edge of window panel 14.

Body portion 22 may be coextruded with a trim or overlay layer 36. Overlay layer 36 is provided as a soft material (i.e., approximately equal to 70 shore A durometer or less) that may contact moveable window panel 14. Overlay layer 36 may comprise a thermoplastic material. In an exemplary embodiment, overlay layer 36 may comprise a thermoplastic vulcanizate. Overlay layer 36 may extend along an outer surface of body portion 22. In an exemplary embodiment, overlay layer 36 may cover an outer surface of base 28 and an outer surface of first and second walls 30, 32 of body portion 22. Overlay layer 36 may also extend along an inner surface of first wall 30. The overlay layer 36 may comprise a solid land 38 disposed in channel 34 on an inner surface of first wall 30. Solid land 38 is provided for stabilizing moveable window panel 14. Solid land 38 may stabilize moveable window panel 14 without fatigue or deformation over time (as may be likely with a rail stabilizer extending from an inner surface of first wall 30). At least a portion of solid land 38 may include a material 40 for reducing friction between moveable window panel 14 and division post 16. Overlay layer 36 may also continue from solid land 38 along at least a portion of an inner surface of base 28. In an embodiment, at least a portion of an inner surface of base 28 may include a material 42 for reducing friction between moveable window panel 14 and division post 16. Overlay layer 36 may also extend along at least a portion of an inner surface of second post 32 of body portion 22.

Materials 40, 42 may comprise any material with a low coefficient of friction. For example, materials 40, 42 may comprise flocking or polyethyelene. Flocking may be comprised of a soft fibrous layer formed from a mixture of fiber and adhesive, which may be electrostatically coated onto division post 16. Although flocking and polyethylene are described in detail, it is understood that various other materials may be used for reducing friction and remain within the spirit and scope of the invention.

Overlay layer 36 defines first and second sealing wings 24, 26. First and second sealing wings 24, 26 are provided for guiding moveable window panel 14 via contact in channel 34. First sealing wing 24 forms a sealing surface on the outside surface of moveable window panel 14 along a rear edge of moveable window panel 14. First sealing wing 24 extends from a free end 44 of first post 30 into channel 34. First sealing wing 24 may comprise a different material than body portion 22. In an exemplary embodiment, first sealing wing 24 may comprise a thermoplastic vulcanizate. In an exemplary embodiment, first sealing wing 24 may comprise a material with a durometer equal to or less than approximately 70 shore A. First sealing wing 24 may be coextruded with body portion 22. First sealing wing 24 may comprise a portion of overlay layer 36 that is coextruded with body portion 22. At least a portion of first sealing wing 24 may include a material 46 for reducing friction between moveable window glass panel 14 and division post 16.

Second sealing wing 26 forms a sealing surface on the inside surface of moveable window panel 14 along the rear edge of moveable window panel 14. Second sealing wing 26 extends from a free end 48 of second post 32 into channel 34. Second sealing wing 26 may comprise a different material than body portion 22. In an exemplary embodiment, second sealing wing 26 may comprise a thermoplastic vulcanizate. In an exemplary embodiment, second sealing wing 26 may comprise a material with a durometer equal to or less than approximately 70 shore A. Second sealing wing 26 may be coextruded with body portion 22. Second sealing wing 26 may comprise a portion of overlay layer 36 that is coextruded with body portion 22. At least a portion of second sealing wing 26 may include a material 50 for reducing friction between moveable window glass panel 14 and division post 16.

First and second sealing wings 24, 26 may oppose each other and may be offset with respect to an axis 51. Axis 51 may be generally perpendicular to the axis of movement of window panel 14 (i.e., axis 21). Accordingly, opposing sealing wings 24, 26 may be offset with respect to lateral axis 51, thereby improving the stability of window panel 14. As shown in FIG. 3, first sealing wing 24 may be disposed closer to base 28 than second sealing wing 26. In some embodiments, second sealing wing 26 may be disposed closer to base 28 than first sealing wing 24.

First and second sealing wings 24, 26 may project in channel 34 toward base 28 of body portion 22. In an exemplary embodiment, first sealing wing 24 may be configured for greater deflection toward base 28 of body portion 22 than second sealing wing 26. For example, as shown in FIG. 3, first sealing wing 24 has a narrower hinge 52 that provides for greater deflection of sealing wing 24 than hinge 54 of second sealing wing 26.

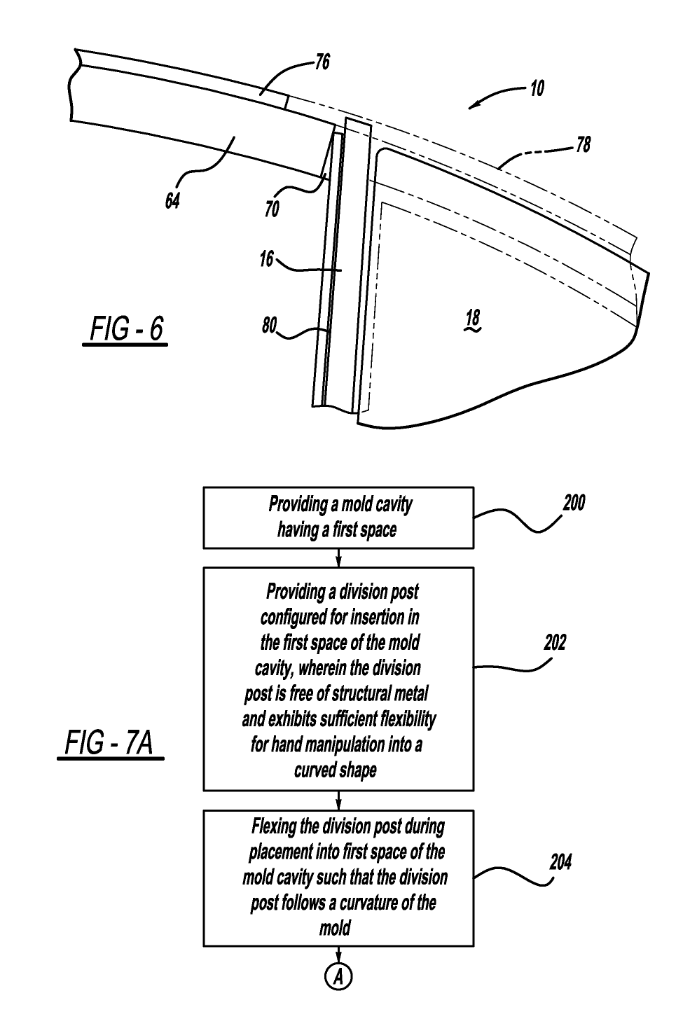

Rear door assembly 10 may further include an integrated trim 20. In an embodiment, integrated trim 20 may be securely attached to fixed window glass panel 18 by virtue of being molded thereon. A molded portion 56 of integrated trim 20 is provided to receive at least an edge of fixed window glass panel 18. Molded portion 56 thereby connects fixed window glass panel 18 to division post 16 and provides tight positive retention of fixed window glass panel 18. Molded portion 56 may comprise a thermoplastic vulcanizate (TPV), thermoplastic polyolefin (TPO), or polyvinyl chloride (PVC). Although these materials are mentioned in detail, it is understood by those of ordinary skill in the art that numerous other polymers may be used and remain within the spirit and scope of the invention. Division post 16 has an encapsulated portion 58 and a non-encapsulated portion 60, the latter of which extends outside the mold cavity during fabrication. Mounting bracket 62 is provided as shown attached to division post 16 in the conventional matter. It is to be understood that additional mounting brackets and the like will ordinarily be present on rear door assembly 10, but could apply to front doors. In addition, bracket 62 is shown as representative of all such mounting hardware. Bracket 62 may be placed directly in mold 74 and embedded in trim 56, as shown in FIG. 6.

Rear door assembly 10 may further include a fully integrated header glass run channel strip 64 and B-pillar portion 66. Header glass run channel strip 64 extends from molded portion 56 of integrated trim 20. B-pillar portion 66 may be attached to header glass run channel strip 64 at corner 68, which will typically have an angle of approximately 90 to approximately 110 degrees. In most applications, header glass run channel strip 64 and B-pillar portion 66 will be extruded as either a single piece or as two separate pieces which are bonded together at corner 68. In most applications, header glass run channel strip 64 and B-pillar portion 66 will be formed of ethylene propylene diene rubber (EPDM), styrene butadiene rubber (SBR) or other thermoset or thermoplastic polymers. Various processing aids and other additives may be appropriate for use in combination with the polymers. Integrated trim 20 may be formed of the same materials. As will be recognized by those of ordinary skill in the art, the length of header glass run channel strip 64 may be dictated by vehicle design, for example, from about 12 inches to about 36 inches.

Outboard wing 72 of header glass run channel strip 64 and first sealing wing 24 may be bonded at corner 70. Outboard wing 72 may be joined by the molded polymer to sealing wing 24 to form a continuous radial trim region which fits securely around and against the corner of moveable window panel 14. An injection molded material may, therefore, fill in the space between outboard wing 72 and sealing wing 24 to form the radial portion at corner 70. Header glass run channel strip 64 and overlay layer 36 may have inside lips (i.e., second sealing wing 26 and the inboard wing (not shown) of header glass run channel strip 64) and outside lips (i.e., first sealing wing 24 and outboard wing 72 of header glass run channel strip 64) for sealing moveable window panel 14. The inside lips are similarly jointed at the radius (i.e., corner) 70 by the injection molded polymer.

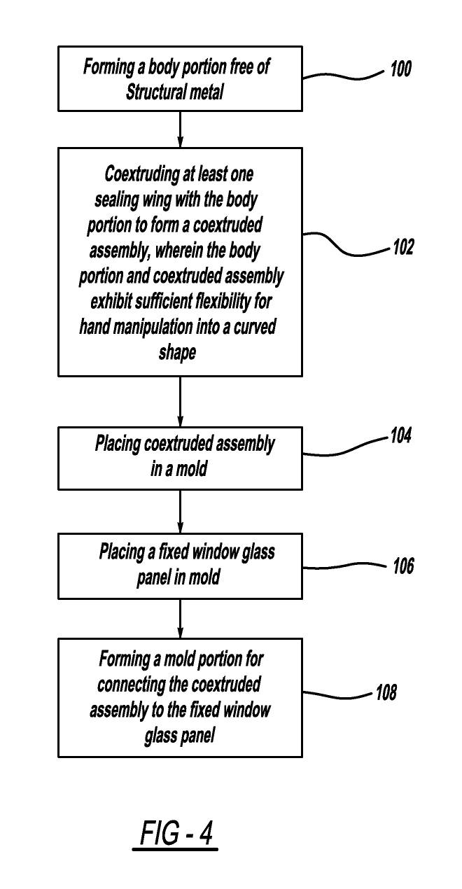

Referring now to FIG. 4, a method of forming a division post assembly for guiding a moveable window panel 14 in a motor vehicle 12 comprises forming and/or providing a body portion 22 free of structural metal in step 100 and coextruding at least one sealing wing 24, 26 with the body portion 22 to form a coextruded assembly in step 102. The body portion 22 comprises a first material and has a generally U-shaped cross-section. The body portion 22 includes a base 28 and first and second opposing walls 30, 32 defining a channel 34. The channel 34 is configured to receive at least an edge of the moveable window panel 14. The sealing wing 24, 26 projects into the channel 34 and comprises a second material that is different than the first material. The body portion 22 and the coextruded assembly exhibit sufficient flexibility for hand manipulation into a curved shape having a first radius of curvature. The first radius of curvature of the body portion 22 and the coextruded assembly can be substantially the same as a second radius of curvature of a mold cavity of a mold into which the coextruded assembly is configured for placement. The first radius of curvature can be at least about 1000 mm in accordance with an embodiment of the invention. The first radius of curvature can be substantially similar to a radius of curvature of a typical vehicle door and glass tumblehome.

Referring now to FIG. 5 of the drawings, a fragment of mold 74 is shown having a mold space 76 which comprises several regions or spaces. Mold space 76 is configured to receive and accommodate fixed window glass panel 18 (shown in phantom), a portion of division post 16, and an end portion of header glass run channel strip 64 as inserts in the mold cavity in accordance with an embodiment of the invention. Accordingly, mold space 76 comprises fixed widow glass panel receiving space 78, division post receiving space 80, and header glass run channel strip receiving space 82. The geometry of these various insert regions or spaces in mold 74 may be a function of the geometry of the inserts. Mold 74 may be provided with the appropriate seal region to retain the molded polymeric material within mold space 76.

Referring now to FIG. 6 of the drawings, a fragmentary portion of mold space 76 is shown in phantom to highlight the relative placement of fixed window glass panel 18, division post 16, and end 78 of header glass run channel strip 64. Mold space 76 may be provided to accept end 78 of header glass run channel strip 64 so that once the thermoset or thermoplastic material (for example, EPDM) is injected, the molded thermoset or thermoplastic material joins with the thermoset or thermoplastic header glass run channel strip 64 and division post 16 and encapsulates fixed window glass panel 18 to form a single unitary integrated trim 20. In an exemplary embodiment, header glass run channel strip 64 may extend into mold space 76 above fixed window glass panel 18 an in some cases reach the belt line. Mold slides may be used to facilitate injection and sealing of the inserts, particularly header glass run channel strip 64 and division post 16 in the mold. The bonding of the molded portion of trim 20 to header glass run channel strip 64 and division post 16 may result in integral joints.

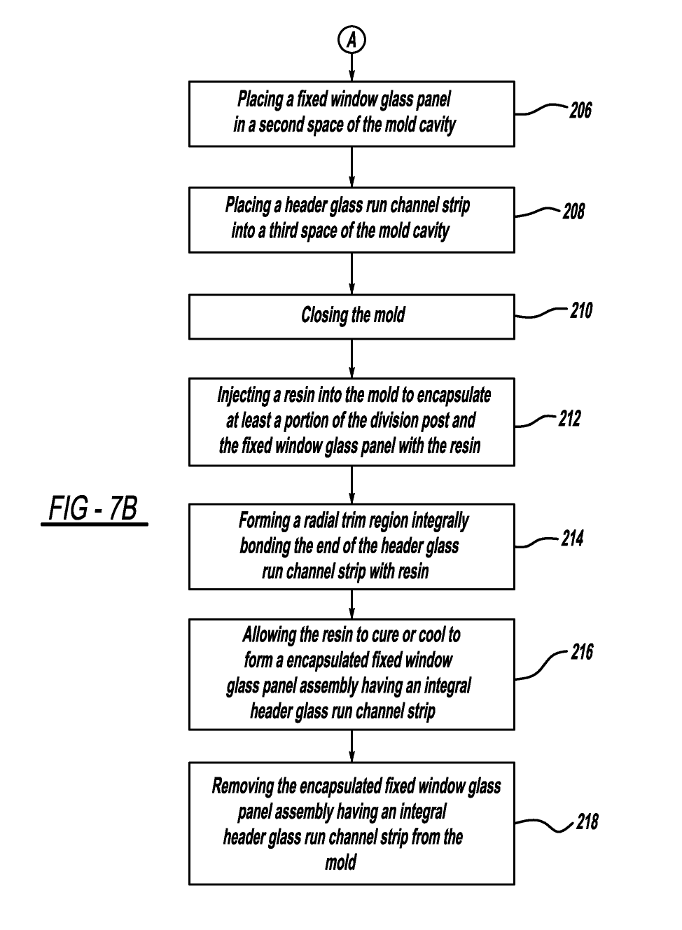

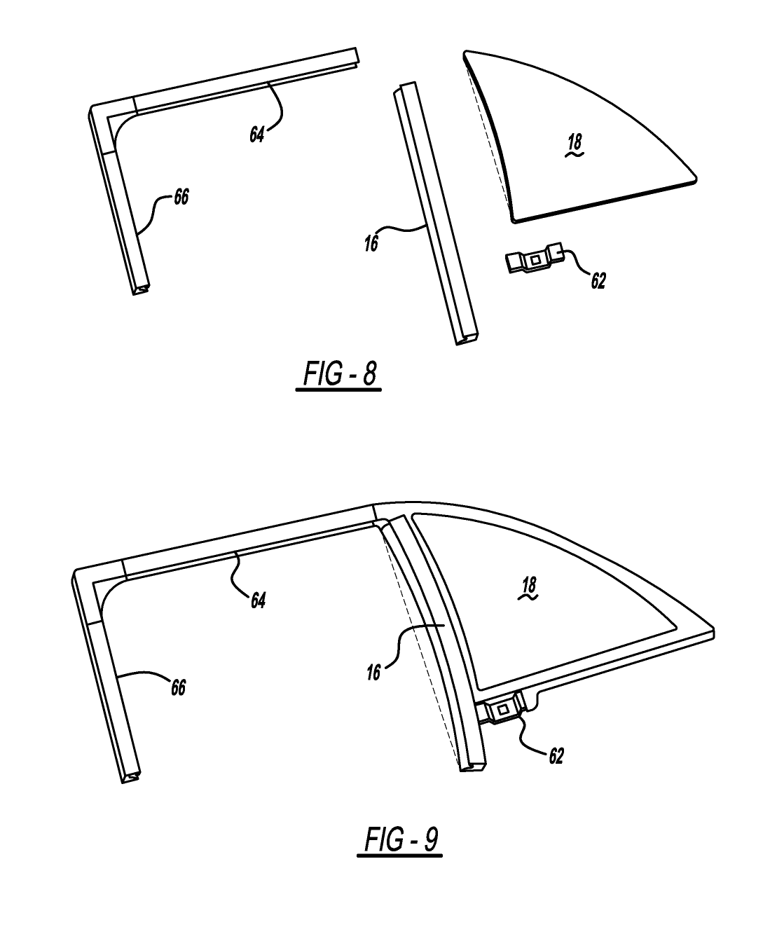

Referring now to FIG. 7, a method of forming a division post assembly comprises providing a mold cavity having a first space in step 200. The method further comprises providing a division post configured for insertion in the first space of the mold cavity, where the division post is free of structural metal and exhibits sufficient flexibility for hand manipulation into a curved shape in step 202. The method of forming a division post assembly further comprises placing the division post 16 into the mold 74. In particular, the straight, flexible division post 16 is flexed during placement of the division post 16 into space 30 of the mold 74 such that the division post 16 follows a curvature of the mold in step 204. The flexibility of the division post 16 allows the division post 16 to naturally follow the curvature of the mold 74 during loading of the division post 16. The straight, flexible division post 16 is manipulated into a curved shape having the first radius of curvature (e.g., at least about 1000 mm) during placement into the mold 74. The division post 16 does not undergo pre-processing or pre-shaping prior to its placement into the mold. The division post 16 is, therefore, manipulated into a curved shape having the first radius of curvature during placement into the mold 74 without undergoing pre-forming or stretch-bending processing before the division post 16 is placed in the mold 74. Referring now to FIG. 8, an exploded view of the division post 16 and fixed window glass panel 18 prior to insertion into the mold is generally illustrated. The division post 16 is straight, and fixed window glass panel 18 is curved. Because the fixed window glass panel 18 has not yet been inserted into the mold 74 during placement of the division post 16 into the mold, the fixed window glass panel 18 has no influence on the final shape of the division post 16. The division post 16 of the inventive method receives its curvature through its insertion into the mold 74.

Referring back to FIG. 7, the method can further comprise providing a fixed window glass panel 18 configured for insertion into the space 78 of the mold 74, placing the fixed window glass panel 18 into second space 78 of the mold 74 in step 206. The fixed window glass panel 18 can be curved in accordance with an embodiment of the invention. The method can further comprise providing a header glass run channel strip 64 configured for insertion in space 82 of the mold 74 and placing one end of the header glass run channel strip into space 82 of the mold 74 in step 208. The header glass run channel strip 64 is adapted to contact a moveable window panel 14. The method can further include closing the mold 74 in step 210 and injecting a resin into the mold 74 to encapsulate at least a portion of the division post 16 with the resin in step 212. The method can further include encapsulating at least a portion of the fixed window glass panel 18 with the resin in step 212. Accordingly, a mold portion 56 is formed for connecting the coextruded assembly to the fixed window glass panel 18. The method can further include forming a radial trim region integrally bonding the end of the header glass run channel strip 64 with the resin in step 214, allowing the resin to cure or cool to form an encapsulated fixed window glass panel assembly having an integral header glass run channel strip in step 216; and removing the encapsulated fixed window glass panel assembly having an integral header glass run channel strip from the mold 74 in step 218. The radial trim region is adapted to seal a portion of the moveable window panel 14. and allowing the resin to cure or cool to form an encapsulated fixed window glass panel assembly. The division post 16 is secured (e.g., bonded) to the curved fixed window glass panel 18 and retains the curvature of the mold 74 after the encapsulated fixed window glass panel assembly is removed from the mold 74. Referring now to FIG. 9, which shows a side elevational view of a portion of a rear door assembly including a division post 16 and fixed window glass panel 18 subsequent to encapsulation of at least a portion of the division post 16 and the fixed window glass panel 18, the division post 16 remains curved after removal from the mold 74, following the curvature of the mold cavity and the fixed window glass panel 18 to which the division post 16 is now secured.

The various injection molding parameters, such as the temperature of the polymer, injection and dwell times, the pressure, and gating will be recognized by those skilled in the art based on the teachings provided by the present invention. For example, a cure (vulcanizing) temperature of from about 320° F. to about 500° F. is appropriate for use with EPDM. It is generally preferred to clean and prime the edges of fixed window glass panel 18 prior to molding.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A method of forming a division post assembly for guiding a moveable window panel in a motor vehicle, the method comprising:
forming a body portion free of structural metal, the body portion comprising a first material and having a generally U-shaped cross-section, the body portion including a base and first and second opposing walls defining a channel, wherein the channel is configured to receive at least an edge of the moveable window panel; and
coextruding at least one sealing wing with the body portion to form a coextruded assembly, the sealing wing projecting into the channel and comprising a second material different than the first material,
wherein the body portion and the coextruded assembly exhibit sufficient flexibility for hand manipulation into a curved shape having a first radius of curvature that is substantially the same as a second radius of curvature of a mold cavity of a mold into which the coextruded assembly is configured for placement.

2. The method of claim 1, wherein the first radius of curvature of the curved shape is at least about 1000 mm.

3. The method of claim 1, further comprising:
placing the coextruded assembly into the mold;
placing a fixed window glass panel into the mold; and
forming a mold portion for connecting the coextruded assembly to the fixed window glass panel.

4. A method of forming a window assembly including a division post, comprising the following steps:
providing a mold having a mold cavity having a first space;
providing a division post configured for insertion in the first space of the mold cavity, wherein the division post is free of structural metal, has a generally U-shaped cross section, and defines a channel adapted to receive a moveable window panel and further wherein the division post exhibits sufficient flexibility for hand manipulation into a curved shape having a first radius of curvature that is substantially the same as a second radius of curvature of the first space of the mold cavity; and
flexing the division post during placement of the division post into the first space of the mold cavity such that the division post follows a curvature of the mold.

5. The method of claim 4, wherein the mold cavity has a second space, the method further comprising:
providing a fixed window glass panel configured for insertion in the second space of the mold cavity; and
placing the fixed window glass panel in the second space of the mold cavity.

6. The method of claim 5, wherein the mold cavity has a third space, the method further comprising:
providing a header glass run channel strip configured for insertion in the third space of the mold cavity, the header glass run channel strip adapted to contact a moveable window panel; and
placing one end of the header glass run channel strip into the third space of the mold cavity.

7. The method of claim 6, further comprising:
closing the mold;
injecting a resin into the mold to encapsulate at least a portion of the division post and the fixed window glass panel with the resin;
forming a radial trim region integrally bonding the end of the header glass run channel strip with the resin, the radial trim region adapted to seal a portion of the moveable window panel;
allowing the resin to cure or cool to form an encapsulated fixed window glass panel assembly having an integral header glass run channel strip; and
removing the encapsulated fixed window glass panel assembly having an integral header glass run channel strip from the mold.

8. The method of claim 4, wherein the resin comprises ethylene propylene diene rubber (EPDM), thermoplastic vulcanizate (TPV), thermoplastic polyolefin (TPO), or polyvinyl chloride (PVC).

9. The method of claim 7, wherein the fixed window glass panel is curved.

10. The method of claim 9, wherein the division post is bonded to the curved fixed window glass panel and retains the curvature of the mold after the encapsulated fixed window glass panel assembly is removed from the mold.

11. The method of claim 4, wherein the division post is manipulated into a curved shape having the first radius of curvature without undergoing pre-forming or stretch-bending processing before the division post is placed in the mold.

12. The method of claim 4, wherein the division post is manipulated into a curved shape having the first radius of curvature during placement of the division post into the mold.

13. The method of claim 4, wherein the division post does not undergo pre-processing or pre-shaping prior to its placement into the mold.
